(19) United States
(12) Patent Application Publication
(10) Pub. No.: US 2026/0096701 A1
(43) Pub. Date: Apr. 9, 2026

(54) TOOL FOR VACUUM-CLEANER BEATER BAR

(71) Applicants: Josh Becker, Hudson, WI (US); Lexi Brunzel, Minong, WI (US); Addyson L. Wolfe, Daytona Beach, FL (US)

(72) Inventors: Josh Becker, Hudson, WI (US); Lexi Brunzel, Minong, WI (US); Addyson L. Wolfe, Daytona Beach, FL (US)

(21) Appl. No.: 18/908,617

(22) Filed: Oct. 7, 2024

(51) Int. Cl. A47L 7/00; A47L 25/00; B25G 1/10; B25G 3/16; B26B 5/00

(52) U.S. Cl. CPC A47L 7/009; A47L 25/005; B25G 1/102; B25G 3/16; B26B 5/00

(57) ABSTRACT

A tool for cleaning a beater bar of an upright vacuum cleaner includes: an ergonomic handle; a cutting head configured to sever elongated strands of debris (such as human hair) wrapped around the beater bar; and a collection head configured to gather and retain the debris upon withdrawal from the beater bar.

### TECHNICAL FIELD

The present technology generally relates to upright vacuum cleaners.

### BACKGROUND

Modern upright vacuum cleaners typically feature a rolling or spinning “beater” bar. The beater bar includes an array of bristles configured to dislodge dirt, dust, crumbs, and other debris from the surface of a floor for subsequent suction into the appliance. However, users find that the beater bar itself requires frequent cleaning, as foreign materials (particularly, human hair) tends to become tightly wound around the bar. Over time, this material can inhibit rotation of the bar, thereby reducing its cleaning functionality. The resulting excess strain on the motor can even permanently damage the appliance. Unfortunately, users have additionally found that the beater bar can be surprisingly difficult to clean, due to, for example: the recessed, hard-to-access position of the beater bar within the vacuum-cleaner head; the high tension securing the hair around the bar; and the smooth, cylindrical outer surface of the bar lacking convenient points from which to begin separating the hair.

### SUMMARY OF THE DISCLOSURE

The present disclosure describes various example features of a customized tool specifically configured to remove debris from the beater bar of an upright vacuum cleaner. More specifically, with respect to elongated debris (e.g., hair, string, etc.) firmly wound around the beater bar, the tools described herein are configured to both cut through the debris and to unwrap the debris for convenient removal.

In one illustrative, non-limiting example, the tool includes a curved or hook-shaped cutting blade with a pointed tip. During use, the user wedges the pointed tip between the debris and the outer surface of the beater bar to initiate separation, and then pulls the tool axially along the beater bar to cut through the debris. After the debris is axially severed, the user can employ the hook-shaped portion of the blade to fully remove the debris from the beater bar. In some examples, the tool further includes a collection head having adhesive properties configured to more fully collect and remove hair and other debris from around the beater bar.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1A is an isometric view of a first example of a tool for cleaning a beater bar of an upright vacuum cleaner.

FIG. 1B is a side-profile view of the tool of FIG. 1A.

FIG. 2A is a truncated side-profile view of an example cutting head for the tool of FIGS. 1A & 1B.

FIG. 2B is another side-profile view of the cutting head of FIG. 2A, depicting some example dimensions thereof.

FIG. 3A-3C are conceptual diagrams illustrating an example technique for using the tool of FIGS. 1A & 1B to clean a beater bar of a vacuum cleaner.

FIG. 4A is an exploded isometric view of another example of the tool of FIGS. 1A & 1B.

FIG. 4B is an exploded side-profile view of the tool of FIG. 4A.

FIG. 5A is an isometric view of an example collection head for the tool of FIGS. 4A & 4B.

FIG. 5B is another isometric view of the collection head of FIG. 5A.

FIG. 5C is a side-profile view of the collection head of FIGS. 5A & 5B disposed within an example hook-and-loop sleeve.

FIG. 5D is an overhead view of the collection head of FIG. 5A-5C.

FIG. 5E is a side-profile view of the collection head of FIG. 5A-5D.

FIG. 5F is a distal-end view of the collection head of FIG. 5A-5D.

FIG. 6A is an isometric view of another example of the tool of FIGS. 1A & 1B.

FIG. 6B is a side-profile view of the tool of FIG. 6A.

FIG. 7A is a side-profile view of another example of the tool of FIGS. 1A & 1B, with a cutting head removably coupled to the ergonomic handle.

FIG. 7B is a side-profile view of the tool of FIG. 7A, with a collection head removably coupled to the ergonomic handle.

FIG. 8A is an isometric view of an example ergonomic handle for the tool of FIGS. 7A & 7B.

FIG. 8B is a side-profile view of the handle of FIG. 8A.

FIG. 8C is a top view or overhead view of the handle of FIGS. 8A & 8B.

FIG. 8D is a distal-end view of the handle of FIG. 8A-8C.

FIG. 8E is another distal-end view of the handle of FIG. 8A-8D.

FIG. 8F is a cross-sectional view of a distal portion of the handle of FIG. 8A-8E.

FIG. 8G is another cross-sectional view of the distal portion of the handle of FIG. 8F, depicting some example dimensions thereof.

FIG. 9 is a side-profile view of an example cutting head for the tool of FIGS. 7A & 7B.

FIG. 10A is a rear isometric view of a first example blade holder for the cutting attachment of FIG. 9.

FIG. 10B is a front isometric view of the blade holder of FIG. 10A.

FIG. 10C is a top view or overhead view of the blade holder of FIGS. 10A & 10B.

FIG. 10D is a side-profile view of the blade holder of FIG. 10A-10C.

FIG. 10E is a distal-end view of the blade holder of FIG. 10A-10D.

FIG. 11A is a rear isometric view of another example blade holder for the cutting head of FIG. 9.

FIG. 11B is a side-profile view of the blade holder of FIG. 11A.

FIG. 11C is a top view or overhead view of the blade holder of FIGS. 11A & 11B.

FIG. 11D is a distal-end view of the blade holder of FIG. 11A-11C.

FIG. 12A is an isometric view of a coupling adaptor for the cutting head of FIG. 9.

FIG. 12B is a side-profile view of the coupling adaptor of FIG. 12A.

FIG. 12C is a top view or overhead view of the coupling adaptor of FIGS. 12A & 12B.

FIG. 12D is a distal-end view of the coupling adaptor of FIG. 12A-12C.

FIG. 13A is an isometric view of another example of the tool of FIGS. 1A & 1B.

FIG. 13B is a side-profile view of the tool of FIG. 13A.

FIG. 13C is an exploded side-profile view of the tool of FIGS. 13A & 13B.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

The present disclosure describes various examples of devices, systems, and techniques for dislodging debris from around a beater bar of an upright vacuum cleaner.

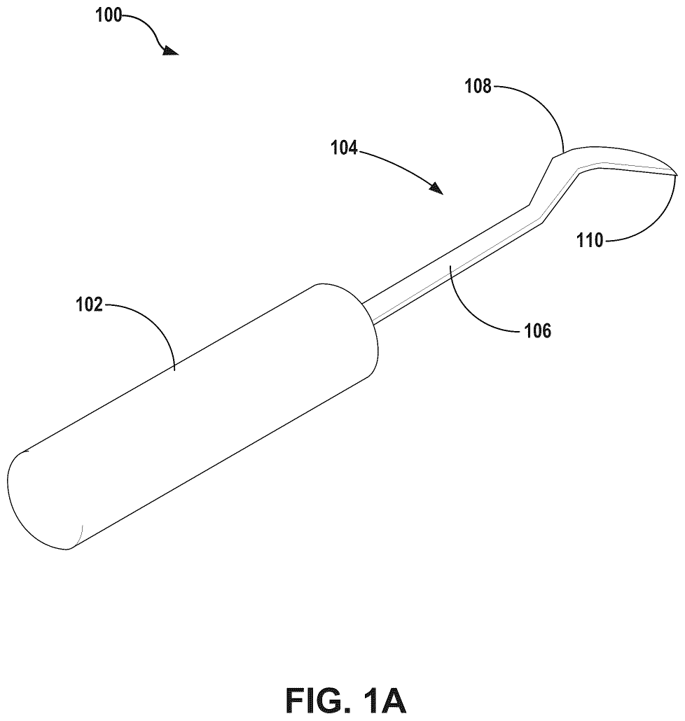

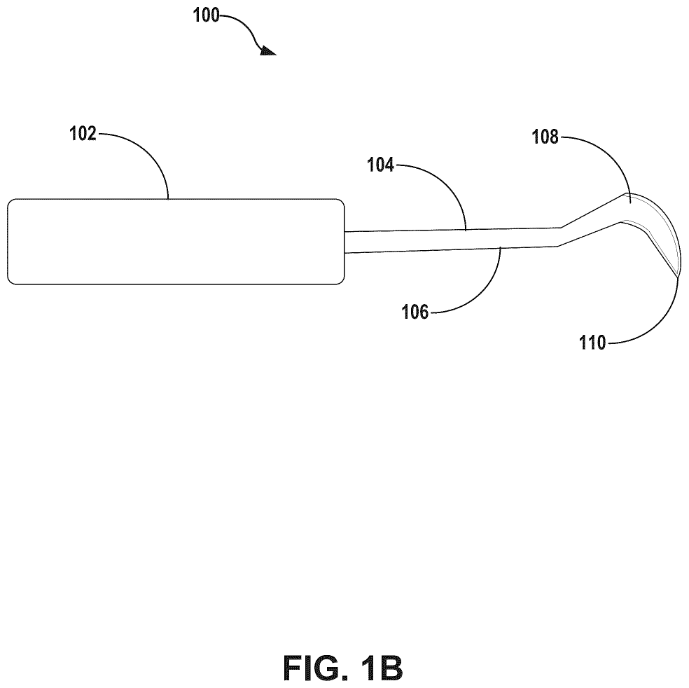

FIGS. 1A & 1B illustrate an example tool 100 for cleaning a beater bar of an upright vacuum cleaner, in accordance with the techniques of this disclosure. As shown in FIGS. 1A & 1B, tool 100 includes at least an ergonomic handle 102, and a cutting head 104 coupled to a distal end of handle 102. Handle 102 may be formed from any suitably durable material, such as hardwood, plastic (e.g., acrylonitrile butadiene styrene (ABS)), another polymer, ceramic, metal, or the like. For instance, in examples in which handle 102 is 3D-printed, handle 102 may be formed from 1.75-mm-diameter PLA printer filament.

Cutting head 104 may be formed from any suitable metal material, such as 20-gauge 304-2B stainless steel. As shown in FIGS. 1A & 1B, cutting head 104 includes an elongated proximal shaft 106, and a curved or hook-shaped blade 108. A distal-most end 110 of cutting head 104 forms a substantially sharp, pointed tip.

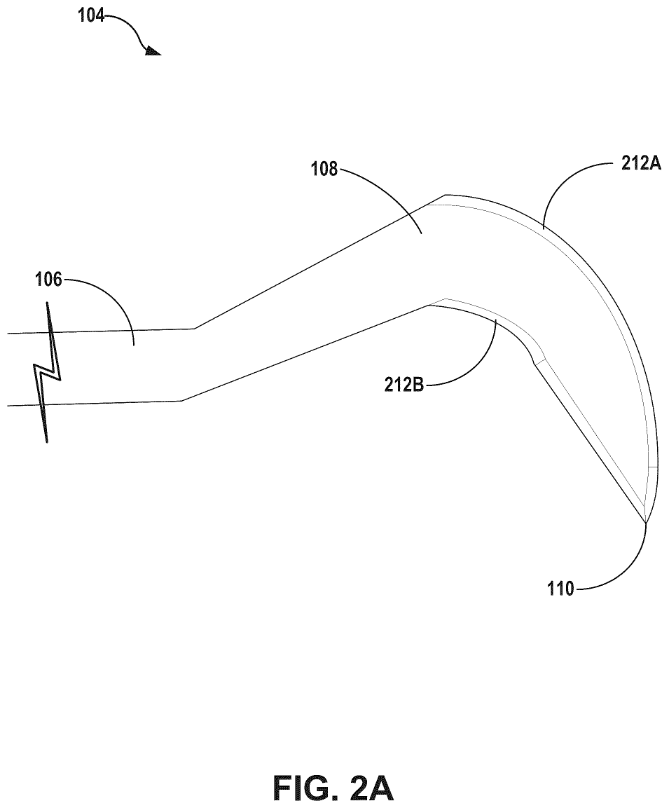

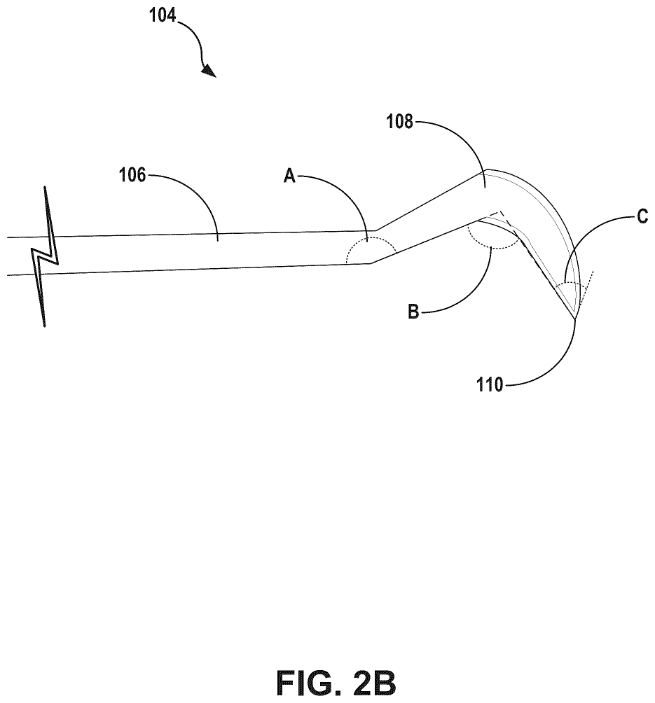

FIG. 2A shows a close-up side-profile view of the hook-shaped blade 108 of cutting head 104 of FIGS. 1A & 1B. As shown in FIG. 2A, hook-shaped blade 108 defines both an upper (or “outer”) cutting edge 212A, and a lower (or “inner”) cutting edge 212B. The respective cutting edges 212A/212B intersect at the blade's distal tip 110.

FIG. 2B is another side-profile view of the cutting blade of FIG. 2A, depicting some illustrative, non-limiting example dimensions thereof. A junction between the elongated shaft 106 and the hook-shaped blade 108 can form an angle “A” of about 150° to about 170°, preferably around 160°. The hook-shaped blade 108 can define an interior angle “B” of about 93° to about 113°, preferably around 103°. And the pointed distal dip can define an interior angle “C” from about 35° to about 55°, preferably between about 40° and 50°, e.g., around 45°.

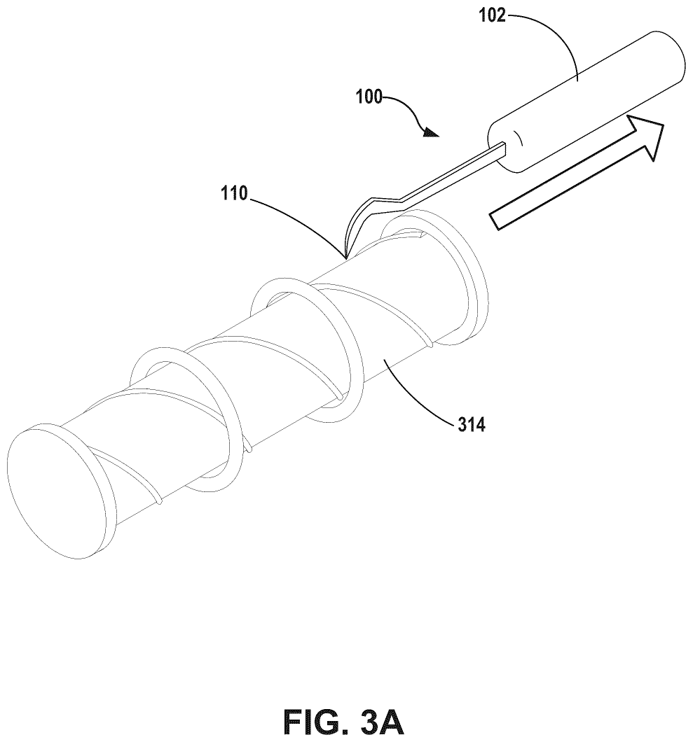

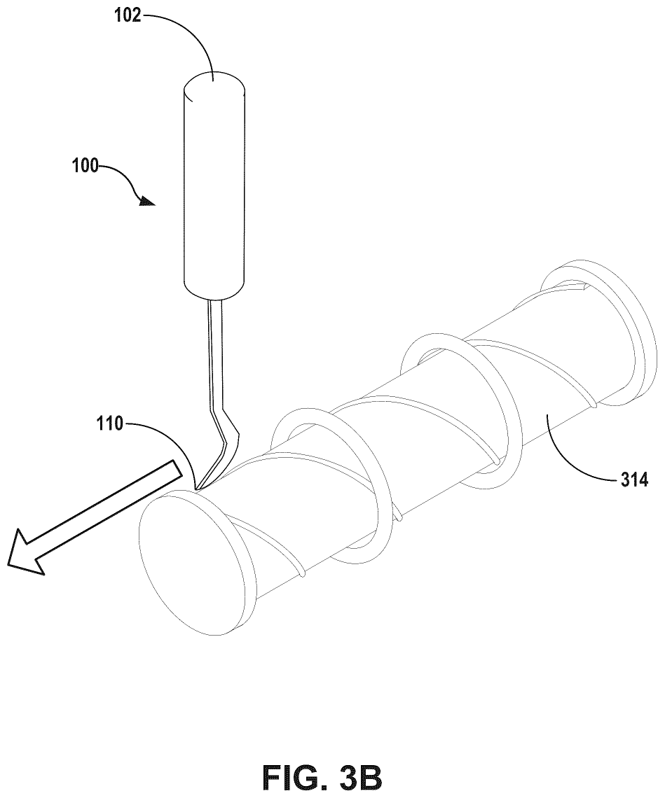

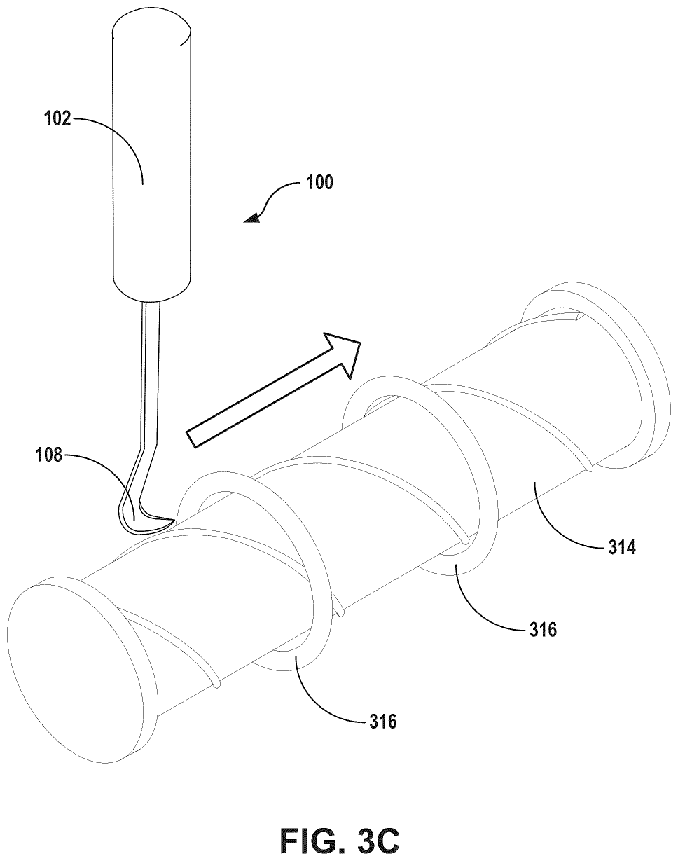

FIG. 3A-3C are conceptual diagrams illustrating an example technique for using the tool 100 of FIGS. 1A & 1B to clean a beater bar 314 of an upright vacuum cleaner. Specifically, FIG. 3A illustrates a “typical” technique for using tool 110, i.e., by dragging the distal tip 110 along the outer surface of beater bar 314 to sever strands of hair, threads, etc. into smaller, conveniently removably pieces. FIG. 3B depicts a technique of re-orienting the distal tip 110 to dislodge debris from within a tight corner of beater bar 314. FIG. 3C depicts a technique of re-orienting the distal tip 110 to dislodge debris from underneath a guard ring 316 of beater bar 314, if present.

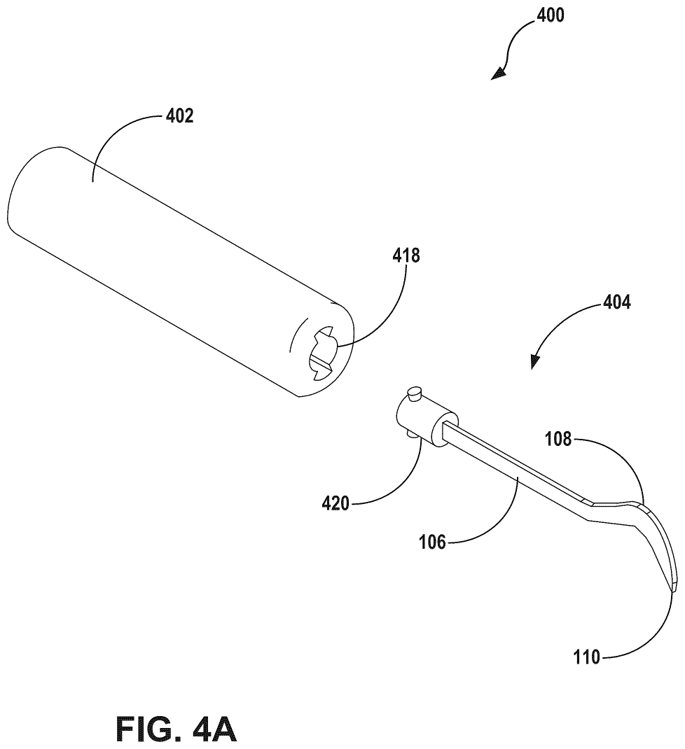

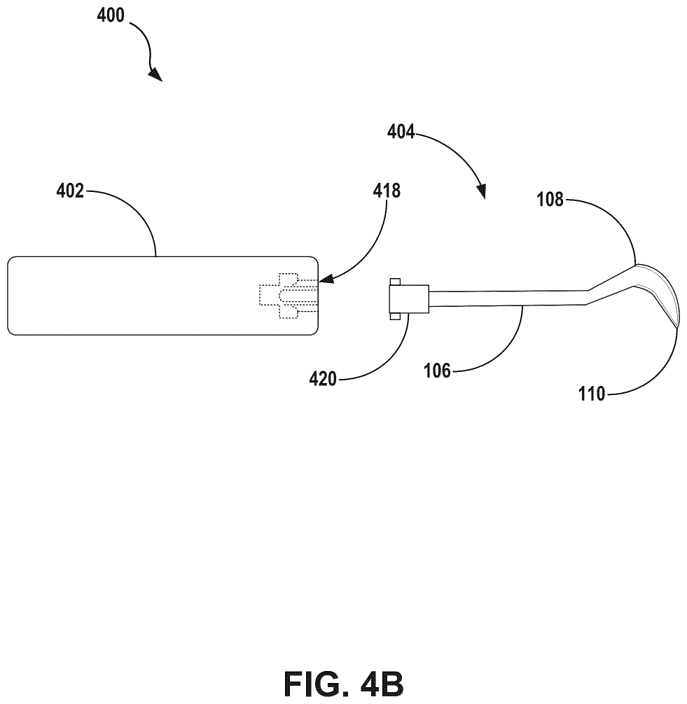

FIGS. 4A & 4B illustrate a tool 400 for cleaning a beater bar 314 (FIG. 3A-3C) of an upright vacuum cleaner. Tool 400 of FIGS. 4A and 4B is another example of tool 100 of FIGS. 1A & 1B, apart from any differences explicitly noted herein. In particular, in the example of FIGS. 4A & 4B, the tool's cutting head 404 (e.g., cutting head 104 of FIGS. 1A & 1B) is configured to removably couple to, and non-destructively de-couple from, ergonomic handle 402 (e.g., handle 102 of FIGS. 1A & 1B).

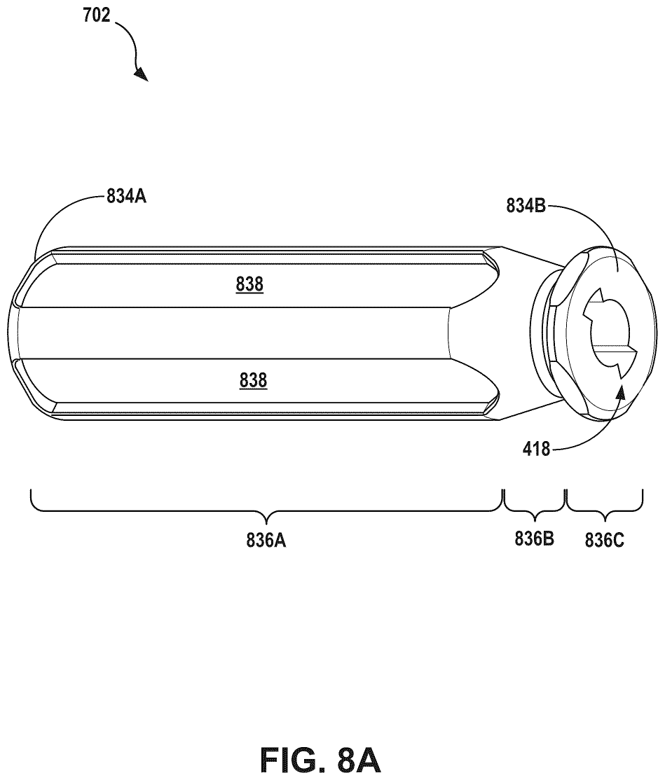

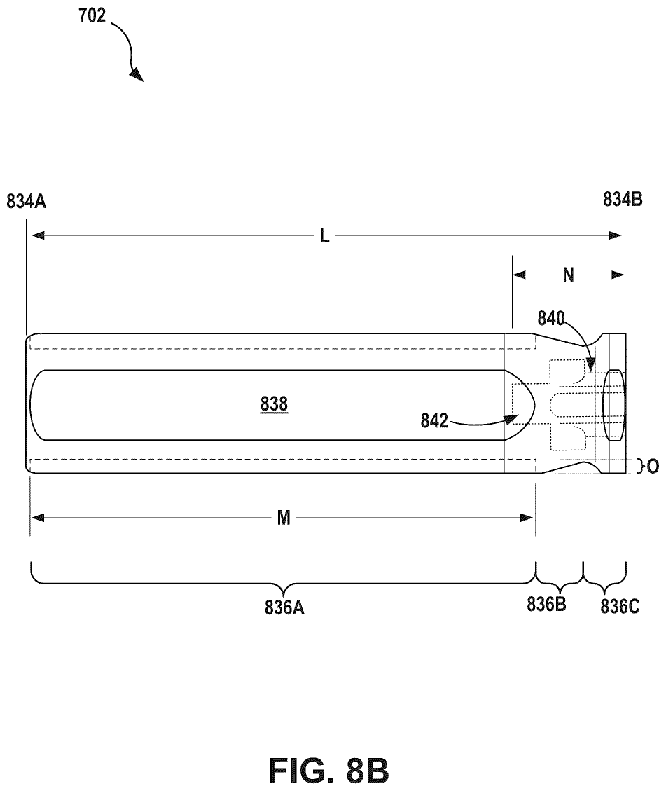

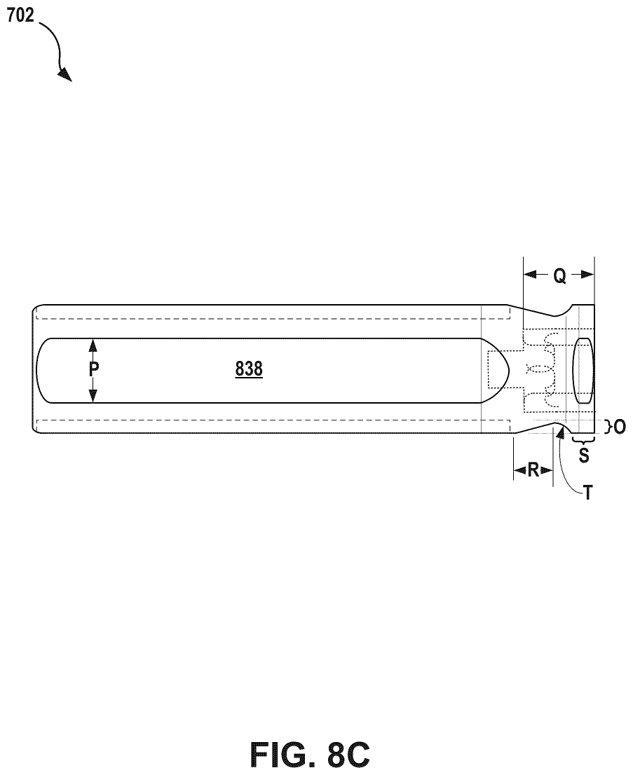

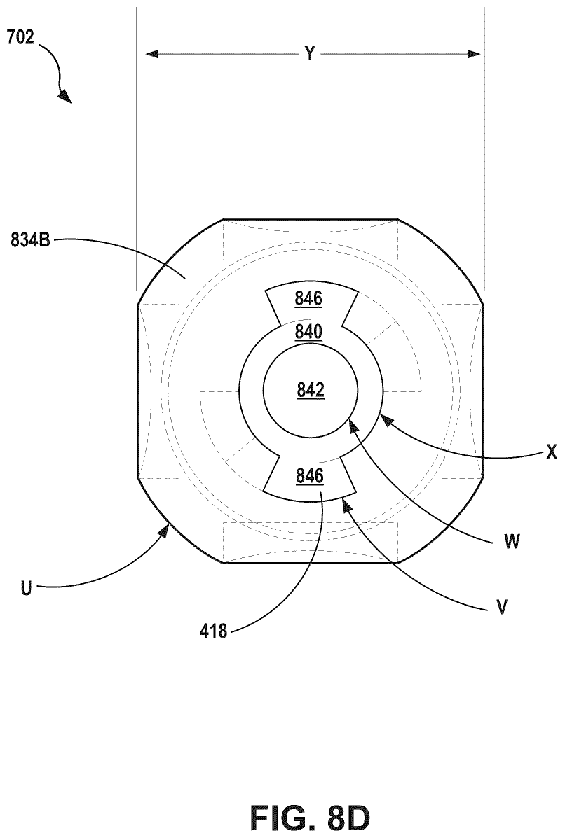

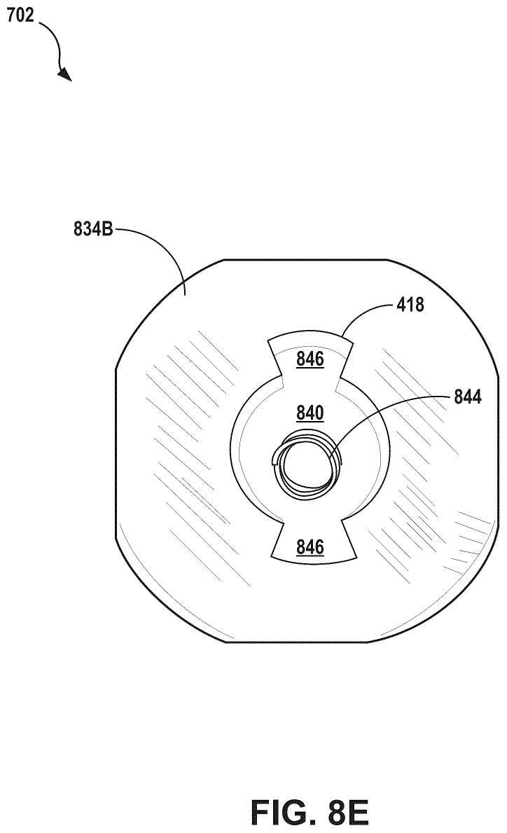

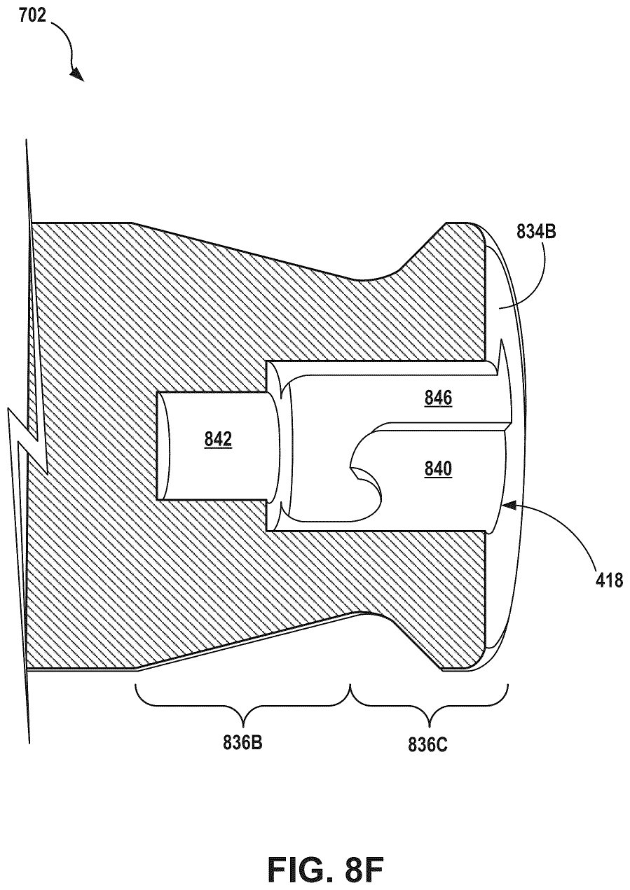

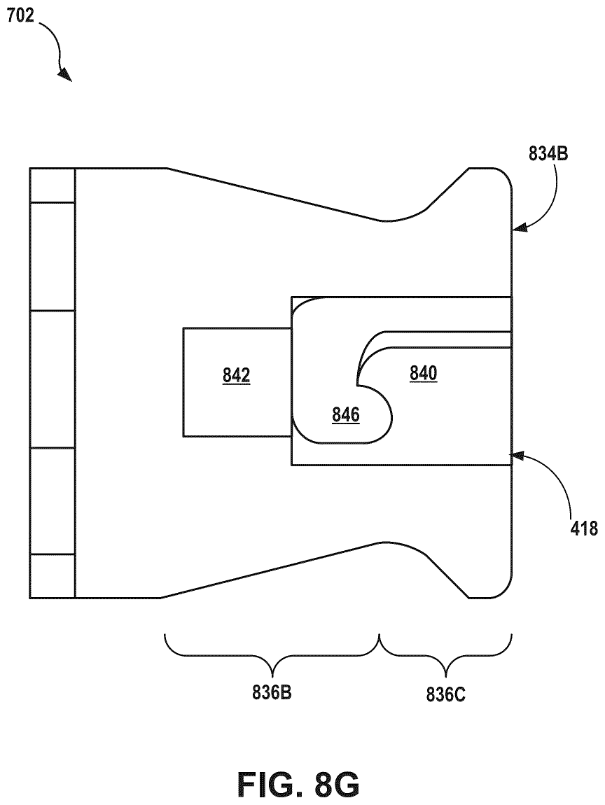

The removable-coupling mechanism can include any suitable connection interface. For instance, in the example shown, tool 400 includes a “bayonet lock” mechanism, in which the distal end of ergonomic handle 402 defines a recess or aperture 418 configured to receive and retain (e.g., via a friction-based connection) a counterpart coupling unit 420 on the proximal end of cutting blade 404. Additionally or alternatively, ergonomic handle 402 and cutting blade 404 can each include a magnet configured to attract one another when placed in sufficiently close proximity. As another example, when oriented so as to repel one another, a pair of opposing magnets could be used to perform the functionality of a central locking spring 844 (see FIG. 8E), i.e., to propel cutting blade 404 distally forward into the “locked” configuration.

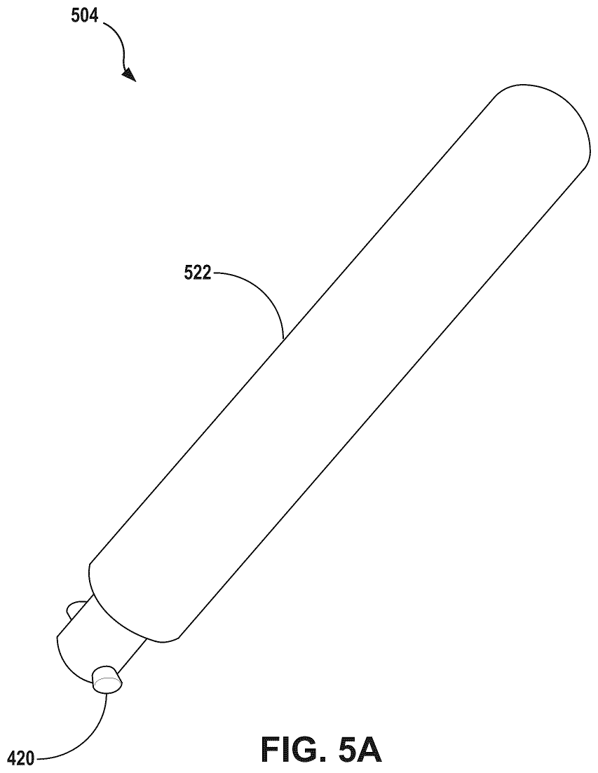

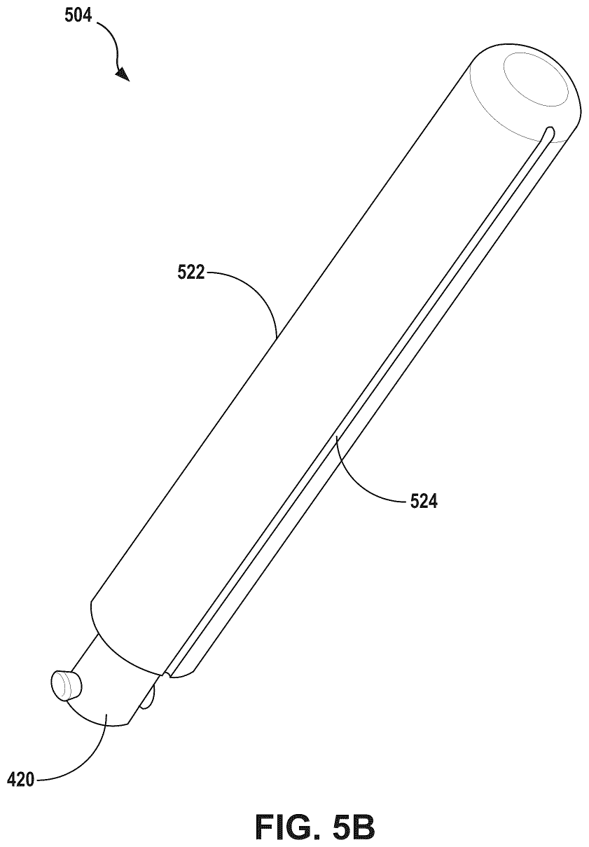

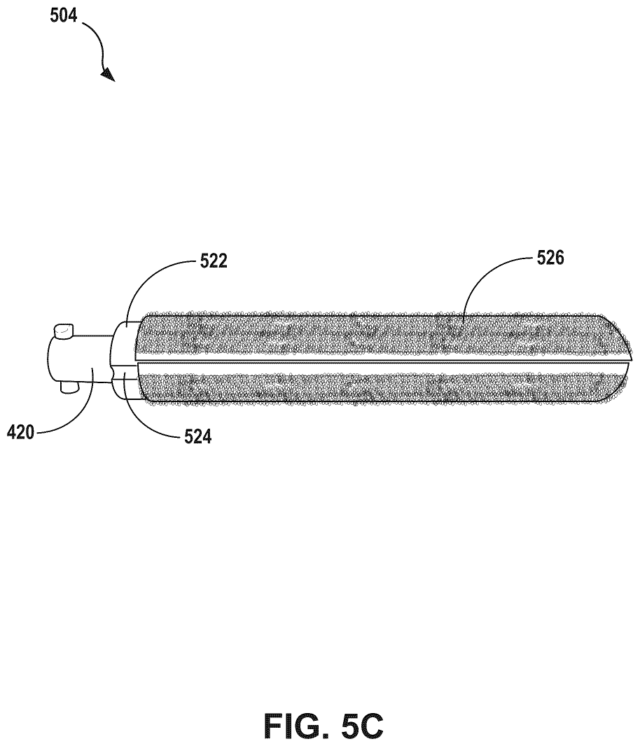

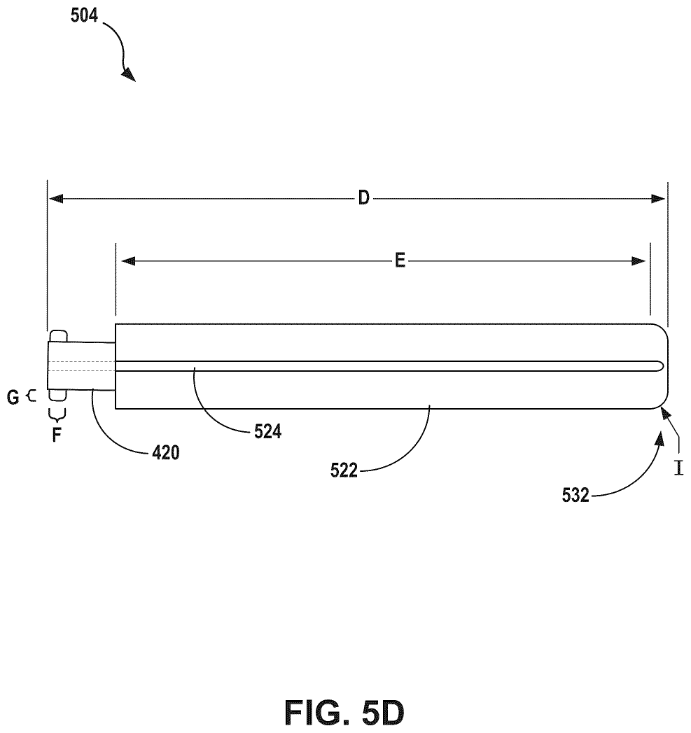

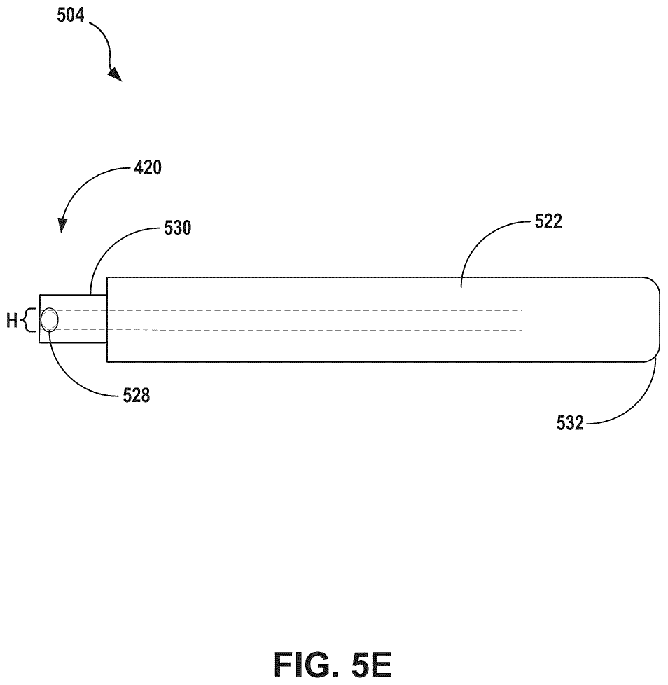

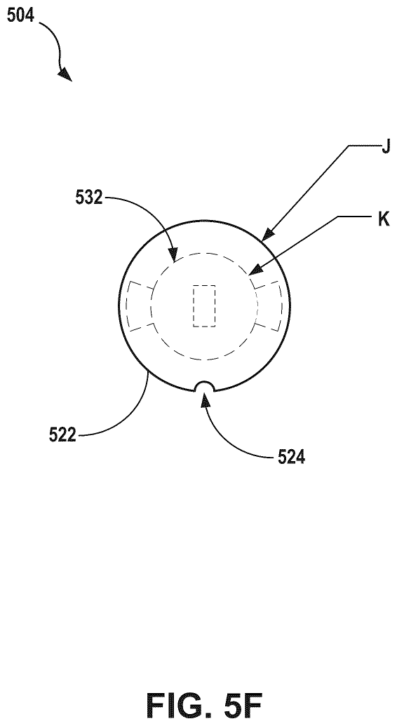

In accordance with techniques of this disclosure, cutting head 404 may be removed from ergonomic handle 402 in order to exchange or replace cutting head 404 with a different tool head (or “bit”), configured for a different function than cutting the hair and other debris from around the beater bar. For instance, FIG. 5A-5F depict another example head or bit of tool 400 that may be removably coupled to ergonomic handle 402. In particular, FIG. 5A-5F illustrate an example collection head 504 configured to collect, retain, and remove hair and other debris after using cutting head 404 to dislodge the debris from the vacuum's beater bar.

Collection head 504 includes an elongated rod 522 configured to provide structure and support for a material having adhesive properties. For instance, a strip of adhesive material, such as duct tape, packing tape, or the like, may be wrapped around the outer surface of elongated rod 522. Additionally or alternatively, elongated rod 522 may be inserted into a “sleeve” or “pocket” of adhesive material. Additionally or alternatively, collection head 504 can include a plurality of tines, similar to those of a curling iron, extending radially outward from the elongated rod 522.

Once elongated rod 522 and the adhesive material are coupled together, the combined unit may be inserted into the interior of the vacuum-cleaner's head in order to collect and remove the loosened debris for convenient disposal. For instance, the user may perform a motion, similar to when using a curling iron, in order to wrap the loosened hair and other debris around the collection head for removal from the vacuum.

As shown in FIG. 5B, in some examples, elongated rod 522 defines a longitudinal groove 524, which can perform multiple different functions. For instance after the collection head 504 has been inserted into the head of the vacuum cleaner to collect the loosened hair and other elongated debris, upon removal, the hair may then become firmly wrapped around the elongated rod. To enable convenient disposal, the user may then slide the tip of a blade, such as tip 110 of cutting blade 404, down along the longitudinal groove 524 in order to sever the hair into even smaller pieces. Additionally or alternatively, longitudinal groove 524 may be used to help retain the adhesive material in place around elongated rod 522. For instance, in examples in which the adhesive material assumes a sleeve-type configuration, the interior surface of the sleeve can feature an elongated tab configured to slide longitudinally within the groove 524, thereby preventing the sleeve from spinning circumferentially around the rod 522. FIG. 5C shows one illustrative, non-limiting example of collection head 504 inserted into an adhesive sleeve 526 formed from a “hook-and-loop” type fabric, most commonly manufactured by the Velcro Company of the United Kingdom.

FIG. 5D-5F illustrate some non-limiting example dimensions of collection head 504. As shown in FIG. 5D, collection head 504 can define an overall length “D” of about 4.5 inches. Within this overall length D is the elongated rod 522, having a longitudinal length “E” of about 3.88 inches, and a removable coupling unit 420 at the proximal end of the the elongated rod 522. In the example shown in FIGS. 5D & 5E, the removable coupling unit 420 includes a pair of pegs 528 extending radially outward from a central shaft 530. Each of the pegs 528 can define a longitudinal length “F” of about 0.08 inches to about 0.16 inches (e.g., around 0.12 inches), a radial height “G” of about 0.05 inches to about 0.15 inches (e.g., around 0.10 inches), and a circumferential width “H” of about 0.12 inches to about 0.22 inches (e.g., around 0.17 inches). The distal end 532 of elongated rod 522 can be chamfered or beveled with a radius-of-curvature “I” of about 0.08 inches to about 0.18 inches, for instance, around 0.13 inches. In examples in which elongated rod 522 has a circular cross-sectional area with a radius “J” of about 0.30 inches, this distal bevel results in distal-most end 532 having a reduced radius “K” of about 0.18 inches.

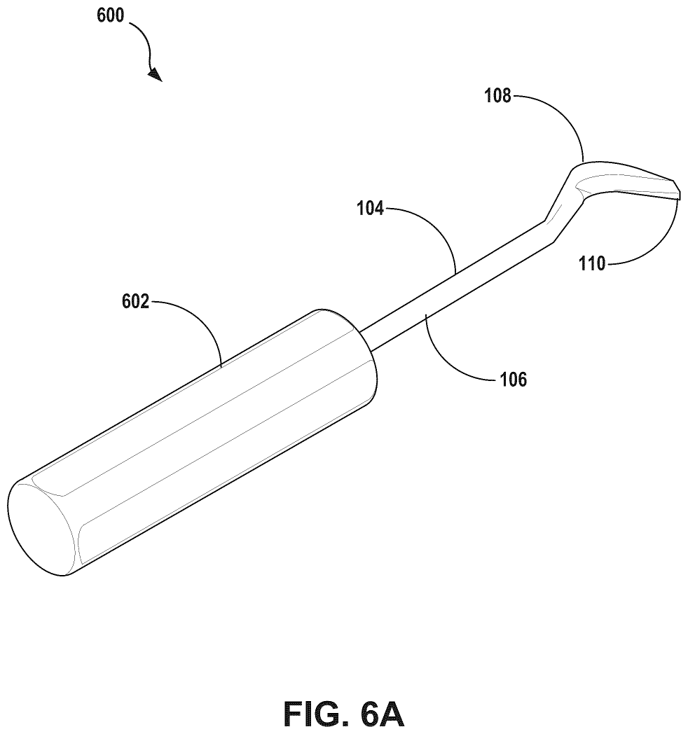

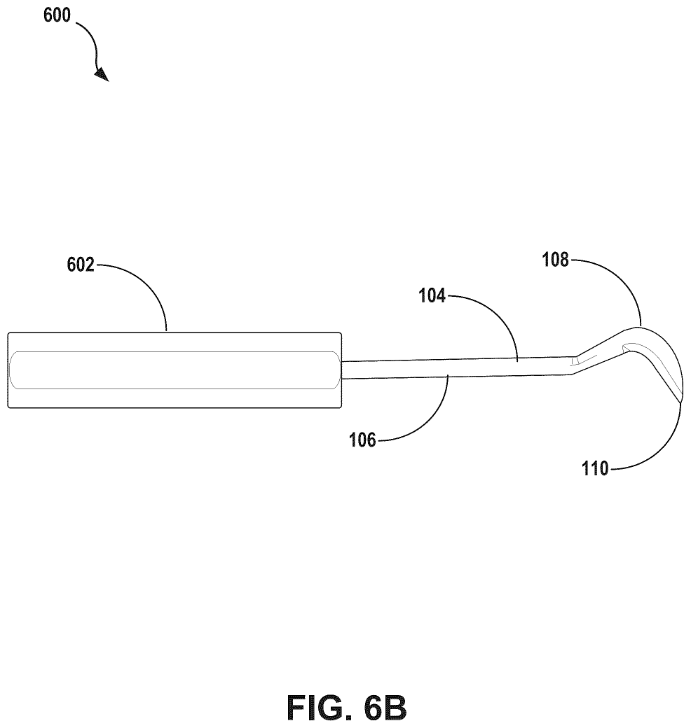

FIGS. 6A & 6B illustrate another example tool 600 for cleaning a beater bar of an upright vacuum cleaner. Tool 600 of FIGS. 6A & 6B is an example of tool 100 of FIGS. 1A & 1B, and of tool 400 of FIGS. 4A & 4B, apart from any distinctions explicitly noted herein.

In particular, unlike tools 100 and 400, depicted as having ergonomic handles 102, 402 (respectively) with substantially circular cross-sectional areas, ergonomic handle 602 of tool 600 features a generally octagon-shaped cross-sectional area. It is to be understood that such configurations, as with any or all other features and aspects described herein, may be included interchangeably within a beater-bar-cleaning tool in accordance with the present disclosure, and should not be considered a conceptually “distinct” embodiment from any single configuration explicitly described.

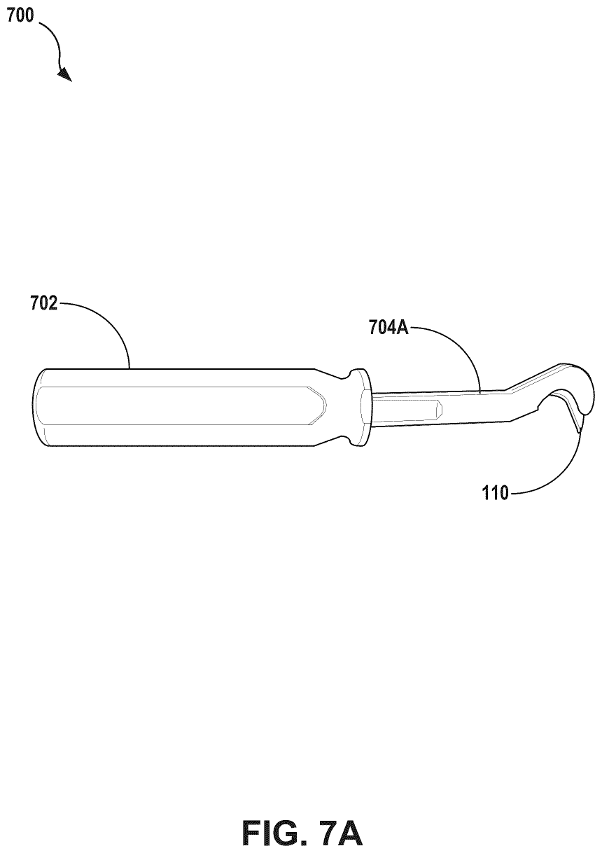

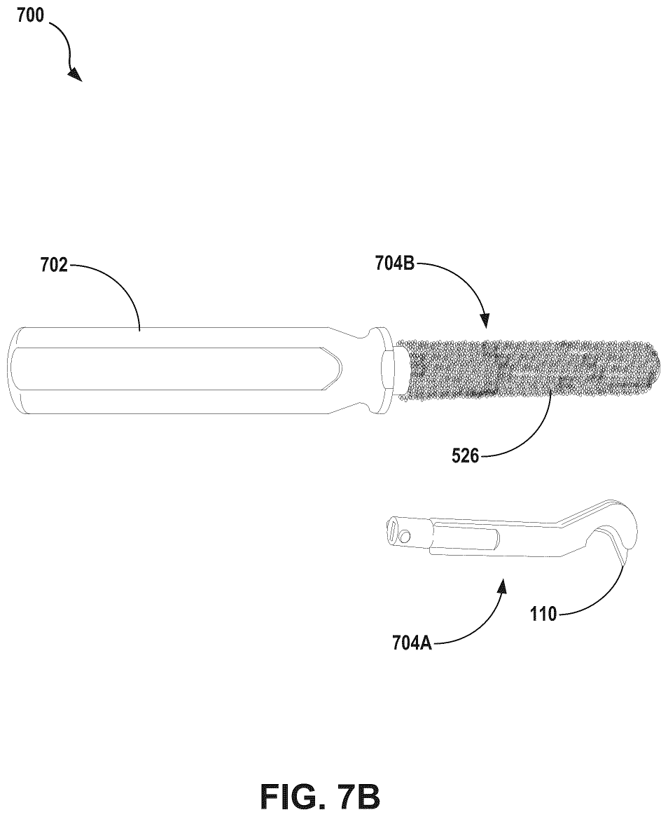

FIGS. 7A & 7B illustrate another example tool 700 for cleaning a beater bar of an upright vacuum cleaner. Tool 700 is an example of tools 100, 400, and 600 as described above, apart from any distinctions explicitly noted herein. As shown in FIGS. 7A & 7B, tool 700 includes an ergonomic handle 702 (e.g., ergonomic handles 102/402/602), a cutting head 704A (e.g., cutting heads 102/402), and a collection head 704B (e.g., collection head 504 of FIG. 5A-5F). In some examples, tool 700 may be manufactured and distributed in the form of a “kit,” e.g., including a single handle 702 and multiple different types of heads, and or multiple different sizes of the same type of head, all of which may be interchanged into the handle 702. For instance, the kit may include the cutting head 704A, a “large” collection head 704B, and a “small” collection head (not shown) for fitting into tighter spaces within the head of the vacuum cleaner.

FIG. 8A-8G illustrate some example features of ergonomic handle 702. In particular, handle 702 features an enhanced ergonomic outer profile. For instance, as shown in FIG. 8A-8G, handle 702 defines a proximal-most end 834A and a distal-most end 834B, for instance, defining an overall longitudinal length “L” (FIG. 8B) of about 3.00 inches to about 5.00 inches, e.g., around 4.00 inches. At the distal-most end 834B, handle 702 can define an eight-sided cross-sectional area, e.g., having two pairs of straight edges spaced apart by a width “Y” (FIG. 8D) of about 0.80 inches to about 1.00 inches (e.g., around 0.90 inches); and four curved edges defining a radius of curvature “U” (FIG. 8D) of about 0.25 inches to about 0.75 inches (for instance, about 0.50 inches).

Handle 702 includes: a proximal gripping portion 836A, a tapered central portion 836B, and a distal bit-coupling portion 836C. Proximal gripping portion 836A can have a longitudinal length “M” (FIG. 8B) of about 3.00 inches to about 3.35 inches (e.g., around 3.37 inches), and tapered central portion 836B can have a longitudinal length “R” (FIG. 8C) of about 0.20 inches to about 0.40 inches (e.g., around 0.28 inches). A proximal side of distal bit-coupling portion 836C can define a radius of curvature “T” (FIG. 8C) of about 0.08 inches to about 0.18 inches, e.g., around 0.13 inches. A distal half of distal bit-coupling portion 836C can define a longitudinal length “S” (FIG. 8C) of about 0.10 inches to about 0.20 inches, e.g., around 0.15 inches.

The proximal gripping portion can define a plurality of recessed grips 838 extending longitudinally toward the tapered central portion 836B, and distributed evenly around the outer circumference of the proximal gripping portion. Recessed grips can have a radial depth “O” (FIG. 8C) of about 0.05 inches to about 0.15 inches (e.g., around 0.09 inches), and a circumferential width “P” (FIG. 8C) of about 0.22 inches to about 0.66 inches, e.g., around 0.44 inches.

At the distal-most end 834B, handle 702 defines a coupling aperture 418 configured to receive a counterpart coupling unit 420 of each of cutting head(s) 704A and collection head(s) 704B. In the present example, coupling aperture 418 is part of a bayonet-type locking mechanism, however, it is to be understood that any suitable additional and/or alternative coupling mechanism may be incorporated, such as magnets, threaded screws, or any functional equivalent.

As shown, the bayonet-type locking mechanism includes a central cavity 840 and a smaller spring cavity 842. Central cavity 840 can have a longitudinal depth “Q” (FIG. 8C) of about 0.40 inches to about 0.60 inches (e.g., around 0.50 inches), and a radius “X” (FIG. 8D) of about 0.15 inches to about 0.25 inches (e.g., around 0.19 inches). Spring cavity 842 can have a longitudinal depth “N” (FIG. 8B) of about 0.60 inches to about 0.90 inches (e.g., around 0.75 inches), and a diameter “W” (FIG. 8D) of about 0.20 inches to about 0.30 inches (e.g., around 0.25 inches).

As shown best in the cross-sectional views of FIGS. 8F and 8G, the central cavity 840 can include a pair of J-shaped recesses 846 configured to receive counterpart pegs of the tool heads' coupling components. As shown in FIG. 8D, the J-shaped recesses 846 form the outermost radius “V” of coupling aperture 418, for instance, about 0.20 inches to about 0.40 inches (e.g., around 0.29 inches). A spring 844 (FIG. 8E) inserted within the spring cavity 842 is configured to “lock” the tool head in place once the pegs are retained within the J-shaped recesses.

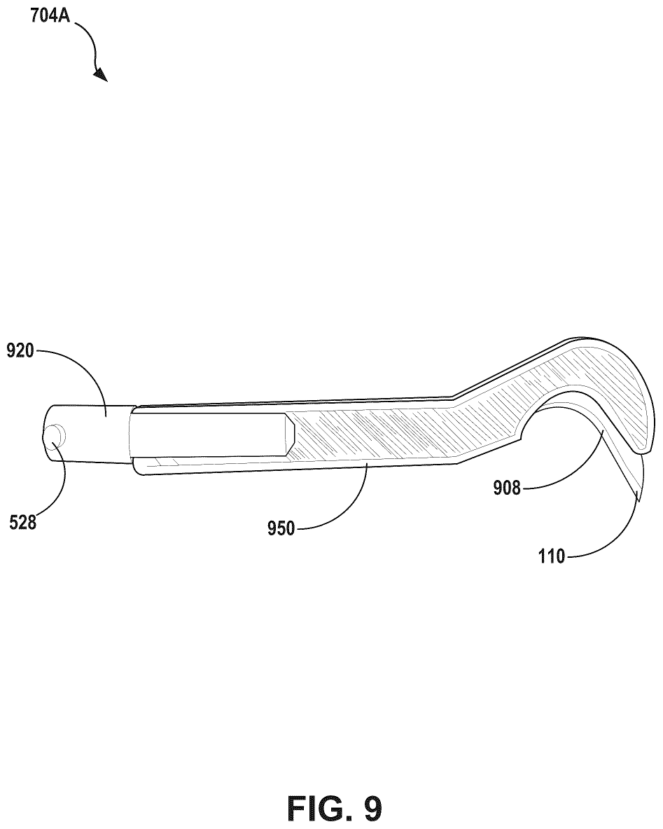

FIG. 9 is a side-profile view showing some example features of the cutting head 704A of FIGS. 7A & 7B. In this example, cutting head 704A includes a metal cutting blade 908 (e.g., blade 108), a proximal coupling adaptor 920 (e.g., coupling unit 420 of FIGS. 4A & 4B), and a blade holder 950.

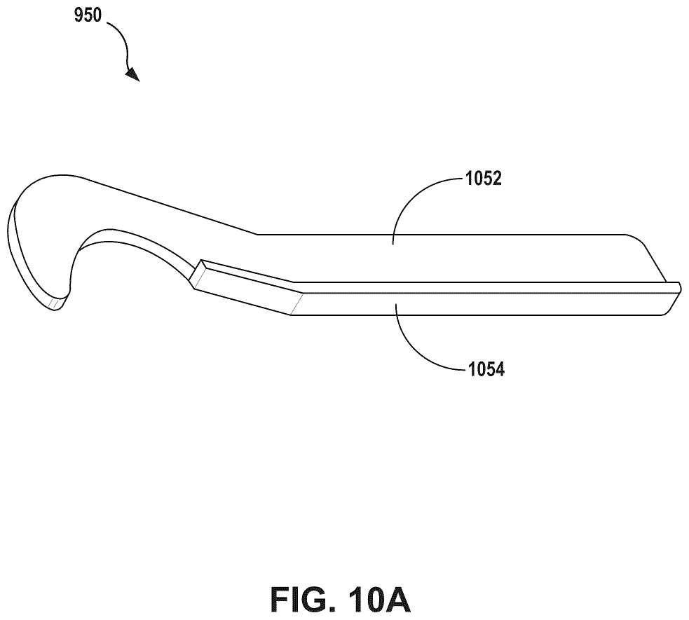

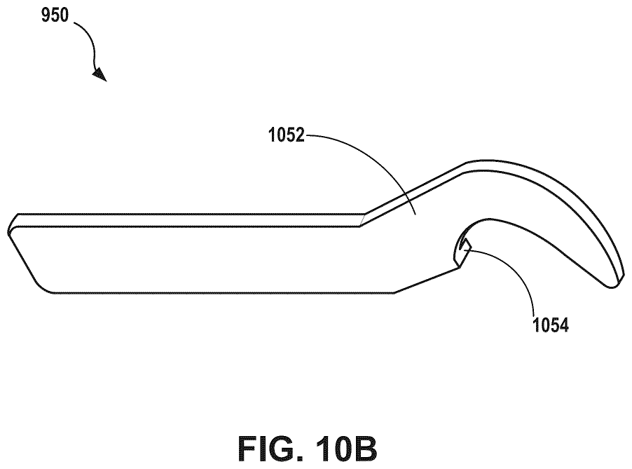

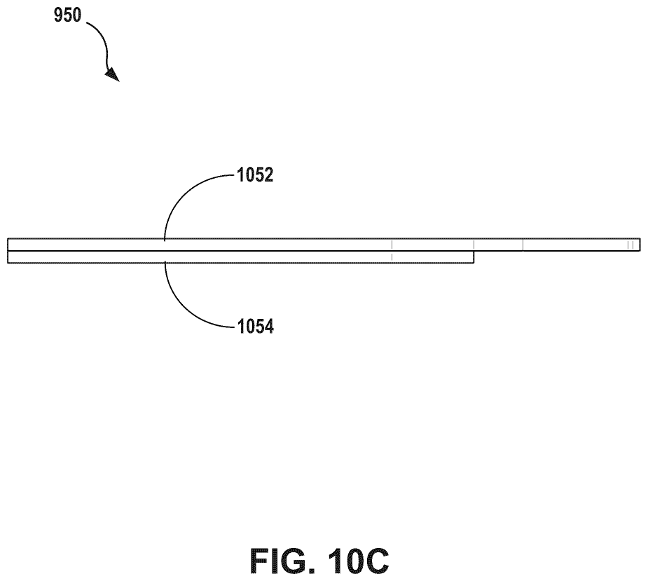

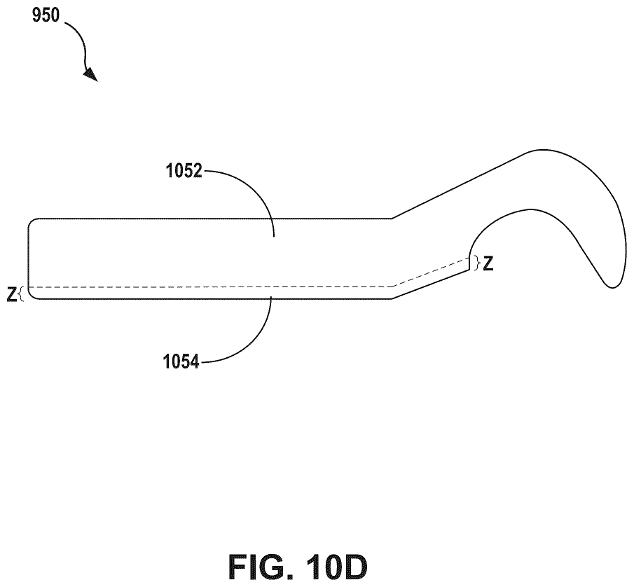

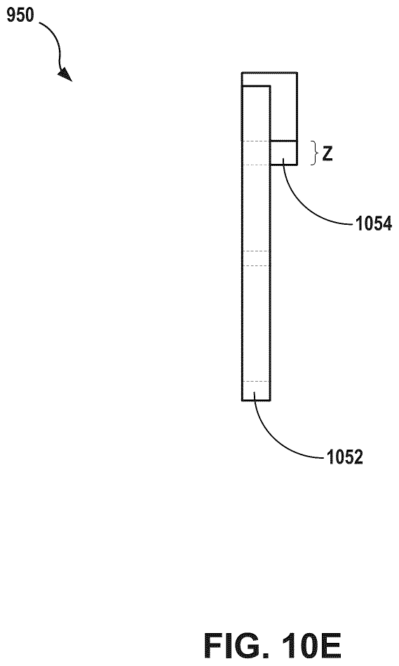

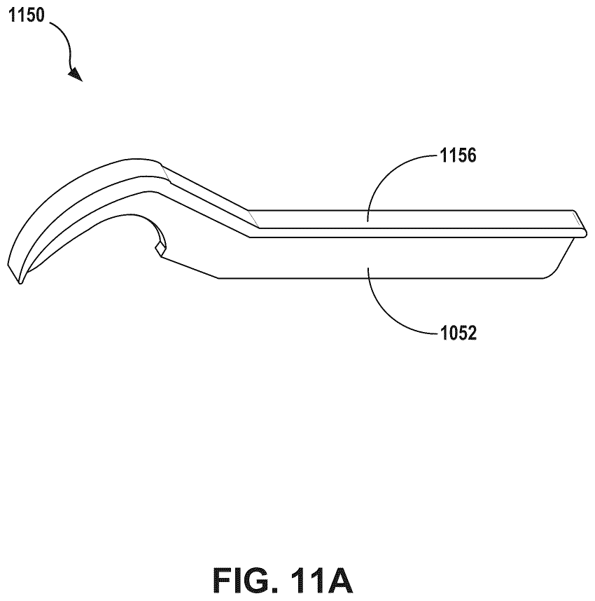

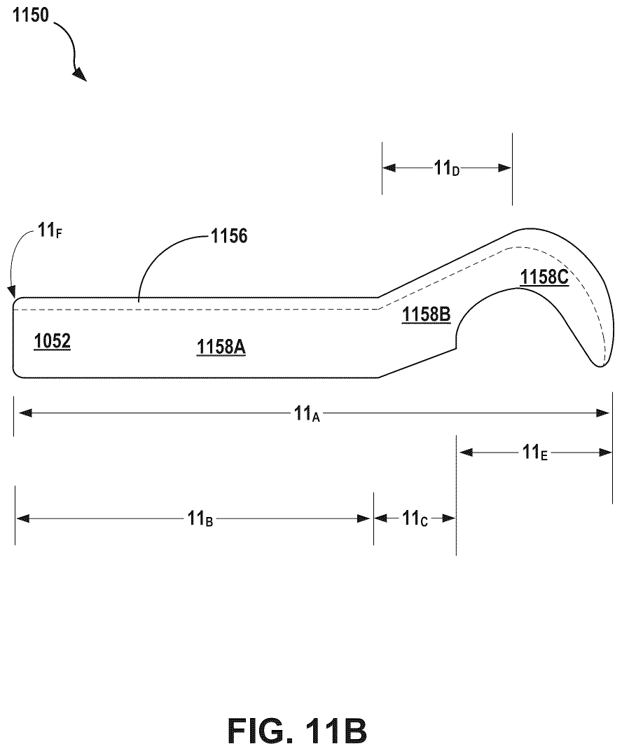

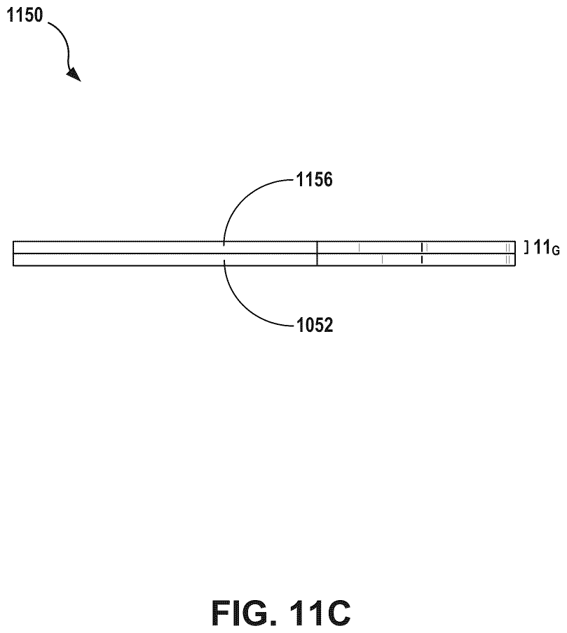

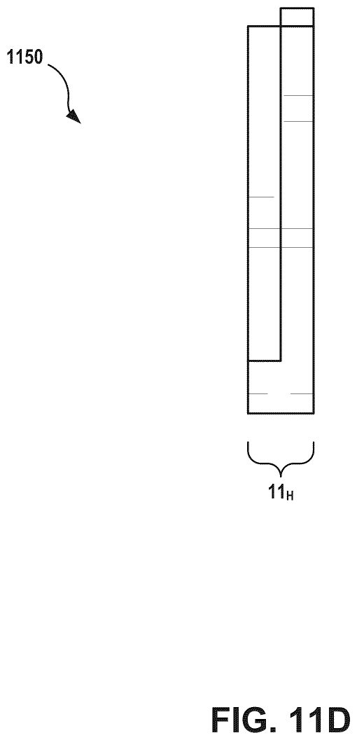

Blade holder 950 is configured to provide structural reinforcement for cutting blade 908, and, in some examples, to act as a safety guard to shield the user from certain portions of the blade 908. FIG. 10A-10E illustrate some example features of blade holder 950. In general, blade holder 950 includes an L-shaped cross-sectional area, defined by a lateral blade support 1052 and a lower blade guard 1054. As shown in FIG. 10D, lower blade guard 1054 may define a thickness “Z” of about 0.03 inches to about 0.09 inches (e.g., around 0.06 inches), in some instances. By contrast, blade holder 1150 of FIG. 11A-11D includes an upper blade guard 1156. In other examples, the blade holder can include both a lower blade guard 1054 and an upper blade guard 1156.

As shown in FIG. 11B, the lateral support 1052 of either of blade holders 950, 1150, can define an overall longitudinal length “11_{A}” (FIG. 11B) of about 2.33 inches to about 4.33 inches (e.g., around 3.33 inches), including a linear proximal portion 1158A, an angled central portion 1158B, and a hooked distal portion 1158C, i.e., that collectively conform to the outer profile of the metal cutting blade 908 (FIG. 9).

In some examples, the proximal portion 1158A can define a longitudinal length “11_{B}” (FIG. 11B) of about 1.50 inches to about 2.50 inches (e.g., around 1.97 inches). The angled central portion 1158B can define a lower longitudinal length “11_{C}” (FIG. 11B) of about 0.20 inches to about 0.60 inches (e.g., around 0.43 inches), and an upper longitudinal length “11_{D}” (FIG. 11B) of about 0.69 inches. The hooked distal portion 1158C can define a longitudinal length “11_{E}” (FIG. 11B) of about 0.40 inches to about 1.20 inches (e.g., around 0.82 inches). In some examples, the corners of blade holders 950, 1150 may be beveled or rounded, e.g., according to a radius of curvature “11_{F}” (FIG. 11B) of about 0.02 inches to about 0.08 inches (e.g., around 0.05 inches). Similar to the lower blade guard 1054, the upper blade guard 1156 can define a lateral thickness “11_{G}” (FIG. 11C) of about 0.03 inches to about 0.09 inches (e.g., around 0.06 inches). The lateral support 1052 and either the lower blade guard 1054 or the upper blade guard 1156 might define a combined lateral thickness “11_{H}” (FIG. 11D) of about 0.08 inches to about 0.18 inches (e.g., around 0.13 inches).

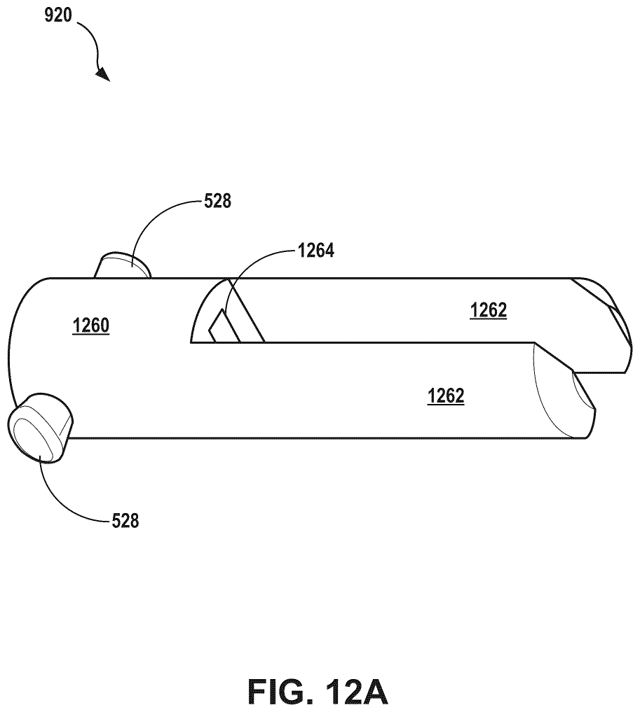

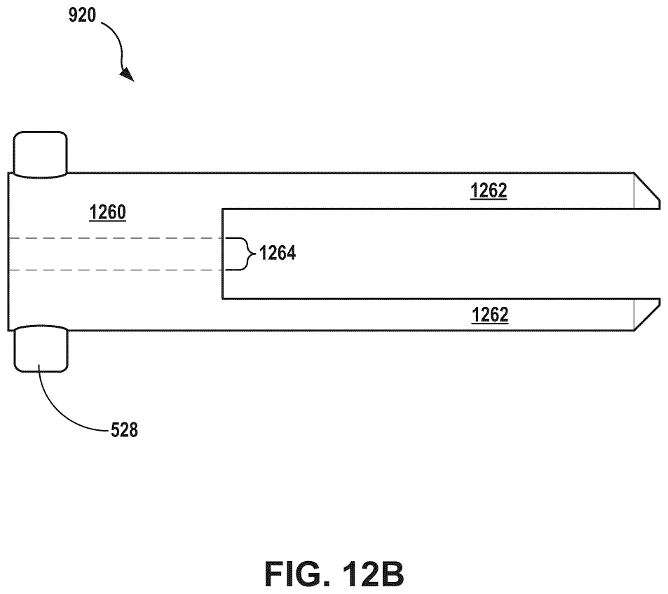

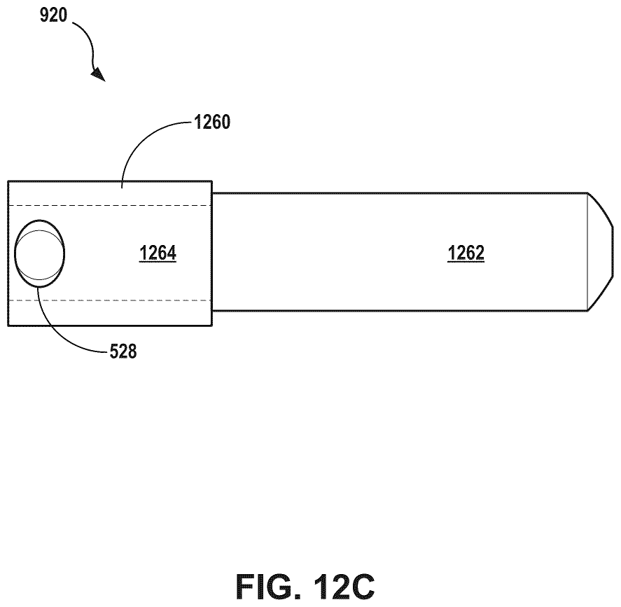

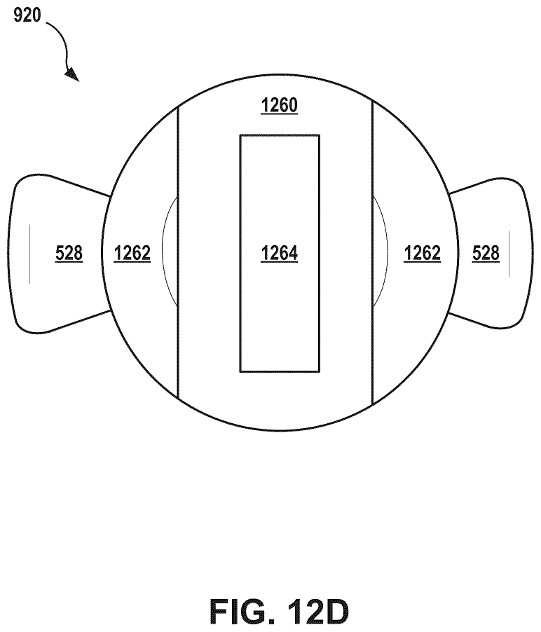

FIG. 12A-12D illustrate some example features of the coupling adaptor 920 for the cutting head 704A of FIG. 9. Coupling adaptor 920 is depicted as a physically distinct component from blade holder(s) 950, 1150, i.e., that may be manufactured separately and then adhered together, e.g., with any suitable adhesive. Such constructions may be advantageous for certain methods of manufacture, such as via 3D printing. In other examples, coupling adaptor 920 and blade holder(s) 950/1150 may be integrally formed as a single component, e.g., when manufactured via injection-molding.

In the present example, coupling adaptor includes a proximal base 1260 having a generally cylindrical outer profile, and a pair of prongs 1262 extending distally outward from the proximal base 1260. Additionally, a pair of coupling pegs 528 (e.g., pegs 528 of FIG. 5E) extends radially outward from the proximal base 1260. During assembly, the proximal ends of metal cutting blade 908 and blade guard 950 are inserted between distal prongs 1262 and fastened into place. In some examples, proximal base 1260 defines a lumen 1264 configured to receive and retain the proximal ends of cutting blade 908 and/or blade guard 950.

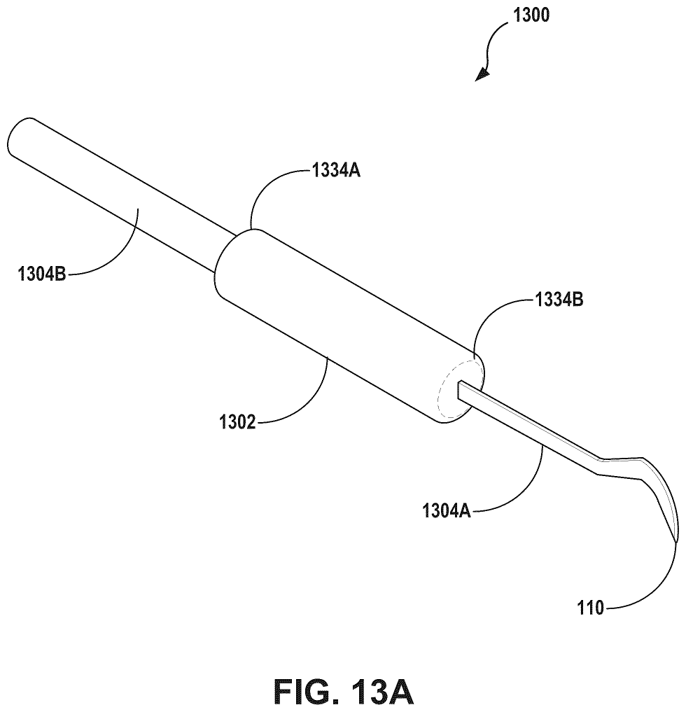

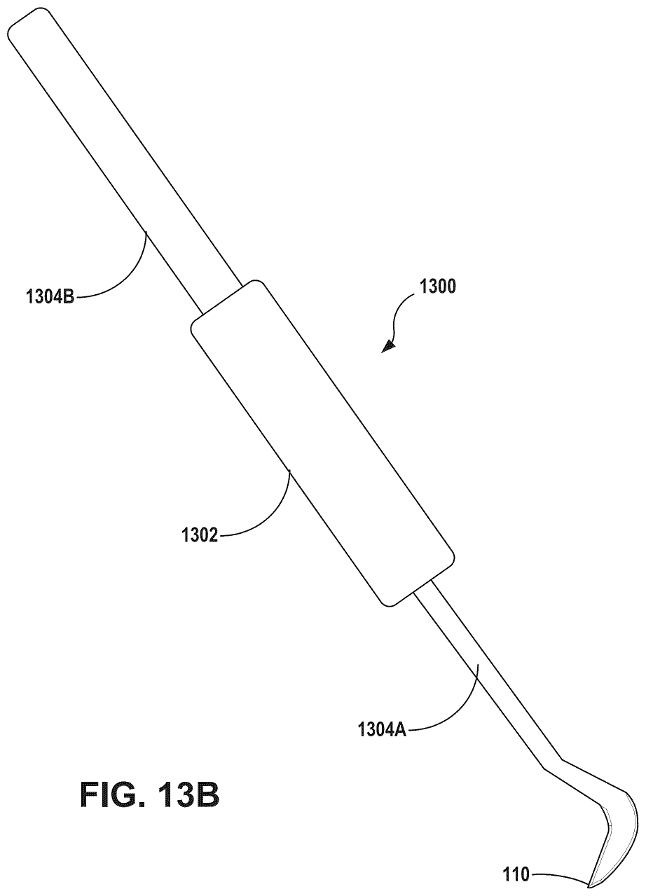

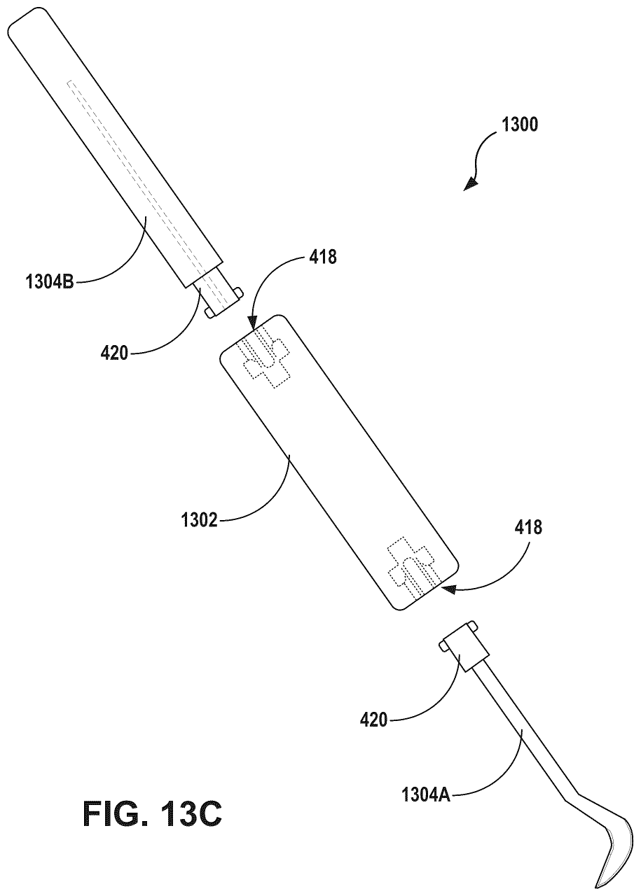

FIG. 13A-13C illustrate another example tool 1300 for cleaning a beater bar 314 (FIG. 3A-3C) of an upright vacuum cleaner. Tool 1300 of FIG. 13A-13C is an example of tools 100, 400, 600, and 700, as described above, apart from any distinctions explicitly noted herein. In particular, tool 1300 assumes a double-ended configuration, wherein tool heads 1304A, 1304B extend longitudinally outward from both the proximal end 1334A and the distal end 1334B of ergonomic handle 1302 (e.g., ergonomic handles 102/402/602/702). For instance, in the example shown in FIGS. 13A & 13B, cutting head 1304A extends distally outward from the distal end 1334B, and collection head 1304B extends proximally outward from the proximal end 1334A, of handle 1302.

As shown in FIG. 13C, tool heads 1304A, 1304B may both be removably couplable to the handle 1302, and in this regard, may be fully interchangeable (that is, may be coupled to either end of the handle). In yet other examples, handle 1302 may not be present (or equivalently, handle 1302 may be integrally formed with one or the other tool head), such that the two tool heads 1304A/1304B may be removably coupled directly to each other's proximal end, in order to form the double-ended-type configuration illustrated here. In any of these examples described, during use, the cutting head 1304A may be de-coupled from the collection head 1304B in order to use cutting head 1304A to clear hair from around the collection head 1304B, as described above.

While examples of this disclosure are amenable to various modifications and alternative forms, specifics thereof shown by way of example in the drawings will be described in detail. It should be understood, however, that the intention is not to limit the disclosure to the particular examples described.

It should be understood that individual steps of the previous examples may be performed in any suitable order and/or simultaneously, as long as the overall technique remains operable. Similarly, various aspects disclosed herein may be combined in different combinations than those explicitly presented in the description and accompanying drawings. Additionally, certain aspects of this disclosure described as being performed by a single module or unit (e.g., for clarity) may also be performed by a combination of units or modules associated with a beater-bar-cleaning tool.

What is claimed is:

1. A tool for cleaning a beater bar of an upright vacuum cleaner, the tool comprising:
an ergonomic handle;
a cutting head configured to sever elongated strands of debris wrapped around the beater bar; and
a collection head configured to gather and retain the debris upon removal from the beater bar.

2. The tool of claim 1, wherein the cutting head and the collection head are configured to removably couple to the ergonomic handle.

3. The tool of claim 2, wherein a distal end of the ergonomic handle defines a coupling aperture configured to receive and retain a respective coupling unit on each of the cutting head and the collection head.

4. The tool of claim 3, wherein the ergonomic handle comprises a spring positioned within the coupling aperture configured to retain the coupling unit of the cutting head or the collection head within the coupling aperture.

5. The tool of claim 3, wherein each coupling unit comprises:
a cylindrical body; and
a pair of pegs extending radially outward from opposite sides of the cylindrical body.

6. The tool of claim 1, wherein the cutting head comprises:
a substantially linear proximal shaft;
a curved hook at a first distal end of the proximal shaft; and
a pointed tip at a second distal end of the curved hook.

7. The tool of claim 6, wherein a proximal end of the curved hook is oriented relative to the distal end of the proximal shaft at an angle of between about 150° and about 170°.

8. The tool of claim 6, wherein the curved hook defines an interior angle of between about 93° and about 113°.

9. The tool of claim 6, wherein the pointed tip defines an interior angle of between about 40° and about 50°.

10. The tool of claim 6, wherein the curved hook defines an inner cutting edge and an outer cutting edge.

11. The tool of claim 1, wherein the cutting head comprises:
a metal blade;
a blade holder extending along two adjacent sides of the metal blade; and
a coupling adaptor.

12. The tool of claim 11, wherein the blade holder and the coupling adaptor are 3-D printed.

13. The tool of claim 11, wherein the coupling adaptor comprises:
a proximal coupling unit comprising a pair of radial pegs; and
a pair of longitudinal prongs configured to retain the metal blade and the blade holder.

14. The tool of claim 1, wherein the collection head comprises an elongated rod defining a longitudinal groove, wherein the elongated rod is configured to retain an adhesive material.

15. The tool of claim 14, further comprising the adhesive material.

16. The tool of claim 15, wherein the adhesive material comprises hook-and-loop-type fabric.

17. The tool of claim 1, wherein the collection head is coupled to a proximal end of the ergonomic handle, and wherein the cutting head is coupled to a distal end of the ergonomic handle.

18. The tool of claim 17, wherein the collection head is configured to removably couple to the proximal end of the ergonomic handle, and wherein the cutting head is configured to removably couple to the distal end of the ergonomic handle.

19. The tool of claim 1, wherein the ergonomic handle comprises a bayonet-type locking mechanism configured to removably retain the cutting head and the collection head.

20. The tool of claim 19, wherein the bayonet-type locking mechanism comprises a central spring configured to removably retain the cutting head or the collection head in a locked configuration.
